(19) United States
(12) Patent Application Publication
(10) Pub. No.: US 2015/0135837 A1
(43) Pub. Date: May 21, 2015

(54) Apparatus for Measuring Acoustic Absorption In-Situ

(71) Applicants: Robert Patrick Dougherty, Bellevue, WA (US); Kevin James Dimond, Seattle, WA (US); Tessa Lynn Robinson, Covington, WA (US); Navid Boostanimehr, Seattle, WA (US)

(72) Inventors: Robert Patrick Dougherty, Bellevue, WA (US); Kevin James Dimond, Seattle, WA (US); Tessa Lynn Robinson, Covington, WA (US); Navid Boostanimehr, Seattle, WA (US)

(73) Assignee: OptiNav, Bellevue, WA (US)

(21) Appl. No.: 14/080,807

(22) Filed: Nov. 15, 2013

(51) Int. Cl. G01N 29/11

(52) U.S. Cl. CPC G01N 29/11
USPC 73/599

(57) ABSTRACT

A phased microphone imaging array and repeatable sound source are used in concert to determine absorption and reflection coefficients of materials and spaces across a continuous frequency domain. Coefficients can be determined at normal and oblique incidences to the surface using beamforming software. The invention can be used in-situ without needing to alter the environment in which it is testing. Accurate results can be obtained at any distance from the array and sound source to the testing surface with relatively little material.

### CROSS-REFERENCE TO RELATED APPLICATIONS

Not Applicable

### FEDERALLY SPONSORED RESEARCH

Not Applicable

### NAME OF PARTIES TO A JOINT RESEARCH AGREEMENT

Not Applicable

### SEQUENCE LISTING

Not Applicable

### BACKGROUND OF INVENTION

### U.S. Patent Literature

| Patent Number | Issue Date | Patentee |
|---|---|---|
| 4,537,630 | August 1985 | Asif |
| 5,884,436 | March 1999 | Gordon |

### Foreign Patent Literature

| Document Number | Issue Date | Applicant |
|---|---|---|
| CN101458231 | June 2009 | UNIV TSINGHUA |
| JP2012052987 | March 2012 | TAKENAKA KOMUTEN |
| | | CO |
| 20120296600 | November 2012 | Wijnant Ysbrand Hans |

### Non Patent Literature

ASTM Standard C423-09a, 2009, “Acoustics—Standard Test Method for Sound Absorption and Sound Absorption Coefficients by the Reverberation Room Method,” ASTM International, West Conshohocken, Pa.
ISO Standard 10534-1:1996, “Acoustics—Determination of sound absorption coefficient and impedance in impedance tubes—Part 1: Method using standing wave ratio,” Geneva, Switzerland
ISO Standard 10534-2:1998, “Determination of sound absorption coefficient and impedance in impedance tubes—Part 2: Transfer-function method,” Geneva, Switzerland
Dougherty, R. P., “What is Beamforming?” Berlin Beamforming Conference, 2008
International Commission for Acoustics, “Measurement Methods of Acoustical Properties of Materials,” Rome Conference, 2001

### FIELD OF THE INVENTION

The technical field that this invention relates to is that of phased microphone imaging arrays and beamforming techniques. Of particular interest are acoustical properties, sound absorption and reflection coefficients, of materials and or spaces.

### DESCRIPTION OF THE RELATED ART

Current methods for calculation of reflection and sound coefficients are cumbersome and time consuming. Methods for both normal and oblique sound incidences exist, but all have drawbacks.

A popular technique for finding sound absorption and reflection coefficients at normal incidence is through use of an impedance tube. Two common methods using the impedance tube are the standing wave method and transfer-function method. The standing wave method can only be calculated for one wave length at a time which is why the transfer-function method is preferred as it uses a continuous frequency range. For more information on the standing wave method refer to ISO 10534-1:1996 and U.S. Pat. No. 4,537,630; for more on the transfer-function method refer to ISO 10534-2:1998 and Foreign Patent JP2012052987. A downside of the transfer-function method is that microphones must be calibrated before the test. Also, impedance tubes are generally limited to frequencies where only plane waves can propagate inside. This is determined by the tubes inner diameter and length, waves longer than half the tube do not register. Thus, impedance tubes have difficulties with low frequencies. They are also limited to only normal incidence and are not useful in-situ as a cylindrical piece of the material has to be inserted into the end of the tube. There are also some measurement devices such as Foreign Patent CN101458231 that use the mathematics of the transfer-function method without the tube which widens the range of frequencies. However, sound waves are free to propagate as forms other than a plane wave and these methods are still limited to normal incidence with placement to the surface at fixed geometry difficult.

In cases where random incident absorption coefficients are of interest the reverberation room method is used. Inside a reverberant room large amounts of the material in question are placed on either the floor, walls, and or ceiling. A reproducible sound is initiated with and without the material. Using the change in the reverberant decay rate, an absorption coefficient can be determined. The coefficient determined using the Sabine equation is not the random absorption coefficient but the Sabine coefficient, both are closely related. For more information on the reverberation room method refer to ASTM C423-09a or U.S. Pat. No. 5,884,436. Using the reverberation room method presents several problems, the first being a large room must be dedicated to this process. It also must be clean, empty, and have favorable acoustic properties. To generate an appreciable difference in decay a large amount of material relative to the room must be used. This poses a problem if the material is expensive, hard to position, or in short supply. Materials that have substantial thickness run into edge effect problems caused by the complex interactions between the edges of the material and resonating waves. The more edges that are exposed the worse the problem even resulting in absorption coefficients greater than 1, theoretically impossible. Also, the Sabine absorption coefficient is only really useful in determining how long it takes for sound to decay in a space and not much else.

It is very difficult to measure sound reflection and absorption in-situ at varying angles of incidence. There is currently no easy to install and use device that can go to a location and measure the acoustic properties from multiple directions without having a problem with the physical environment, most require the environment to be altered. A few that require the least alteration use sound sources and microphones by generating a reflection off of the region of interest and comparing that to a really good reflector producing an absorption ratio, for more information refer to “Measurement Methods of Acoustical Properties of Materials,” International Commission for Acoustics, Rome conference, 2001 and Foreign Patent 20120296600. Generally, these methods must be close to the surface and or use only an impulse to eliminate echoes picked up off other surfaces. They continue to suffer from limitations due to in-situ geometry.

Using the inventions phased microphone array, the problems of varying angles of incidence, limited frequency domain, requiring excess material, edge effects, and not being able to accurately measure in-situ are solved. Phased microphone arrays are a grouping of microphones in an optimized pattern. Due to the known geometry the relative phase difference from when each microphone detects a sound wave allows beamforming software to determine where the source is. Not only is the source located, but also the magnitude of intensity coming from that source is separated from other sources.

### BRIEF SUMMARY OF THE INVENTION

The invention consists of a phased microphone imaging array and repeatable sound source in combination for calculation of sound absorption and reflection coefficients. Placed at known coordinates relative to each other, the source emanates a sound which reflects off the material or space in question and is recorded by the array. Data from a reference microphone array on the source and from the phased array is then analyzed with beamforming software to determine the power reflected from the surface. Power incident is determined beforehand with an approximately yearly calibration test where a near perfect reflecting material is used with the phased array and noise source configuration. Power reflected from the surface is assumed to be the power incident in this case. Using the ratio of the square of power reflected over the square of power incident, the absorption coefficient can be found.

The advantage of this system is that it can determine absorption coefficients of materials in-situ and much more conveniently than existing systems. Because of the systems compact size, it can be moved to any location, positioned at the target in question, and provide coefficients on the spot. Due to the beamforming mathematics, the yearly calibration allows the user to freely point at anything, use the laser distance finder 8 or other device to measure distance, take data, and discover the acoustic properties.

To operate the invention, one would first need to identify the desired angle of incidence. Next, setup the array and sound source in the correct positions, if normal incidence is desired the array and sound source should be placed right next to each other with bleedover protection in place. Using a preferred method measure the distance from the array and sound source to the point of reflection. Record a few seconds of acoustic data with the sound source and using the beamforming software retrieve the reflection power squared. Performing calculations with reflection power squared and the predetermined power incident squared yields absorption and reflection coefficients.

### BRIEF DESCRIPTION OF DRAWINGS

FIG. 1 illustrates the phased microphone imaging array.

FIG. 2 illustrates how the sound source reflects sound waves off the material or surface being tested and back to the array.

FIG. 3 illustrates the sound source and microphone array configuration with bleedover protection between the two.

FIG. 4 is a diagram illustrating the key components of the invention.

FIG. 5 is a flow chart of how the data collection process works.

FIG. 6 is a front view illustration of an imagined final product of the invention.

FIG. 7 is a back view illustration of an imagined final product of the invention.

FIG. 8 illustrates how beamforming visualizes an imaginary sound source for calculations.

FIG. 9A plots the beamforming results on 2.9 (cm) deep water at 1000 (Hz).

FIG. 9B plots the beamforming results on carpet at 1000 (Hz).

FIG. 10A plots the beamforming results on 2.9 (cm) deep water at 2000 (Hz).

FIG. 10B plots the beamforming results on carpet at 2000 (Hz).

FIG. 11A plots the beamforming results on 2.9 (cm) deep water at 5010 (Hz).

FIG. 11B plots the beamforming results on carpet at 5010 (Hz).

FIG. 12 plots absorption coefficients for three materials tested with the Side by Side configuration.

FIG. 13 plots absorption coefficients for three materials tested with the I-Joist configuration.

FIG. 14 plots absorption coefficients of carpet tested with both I-Joist and Side by Side configurations.

FIG. 15 plots absorption coefficients of fiberglass panels tested with both I-Joist and Side by Side configurations.

FIG. 16 plots theoretical and experimental absorption coefficients for a curtain stretched out above the ground forming a cavity of height 2.9 (cm).

### DETAILED DESCRIPTION OF INVENTION

### Symbols

I intensity
P sound power
P_{inc} incident power
P, reflected power
R reflection coefficient
x₁ distance from phased array to test surface
x₂ distance from sound source to test surface
α absorption coefficient
θ angle of incidence

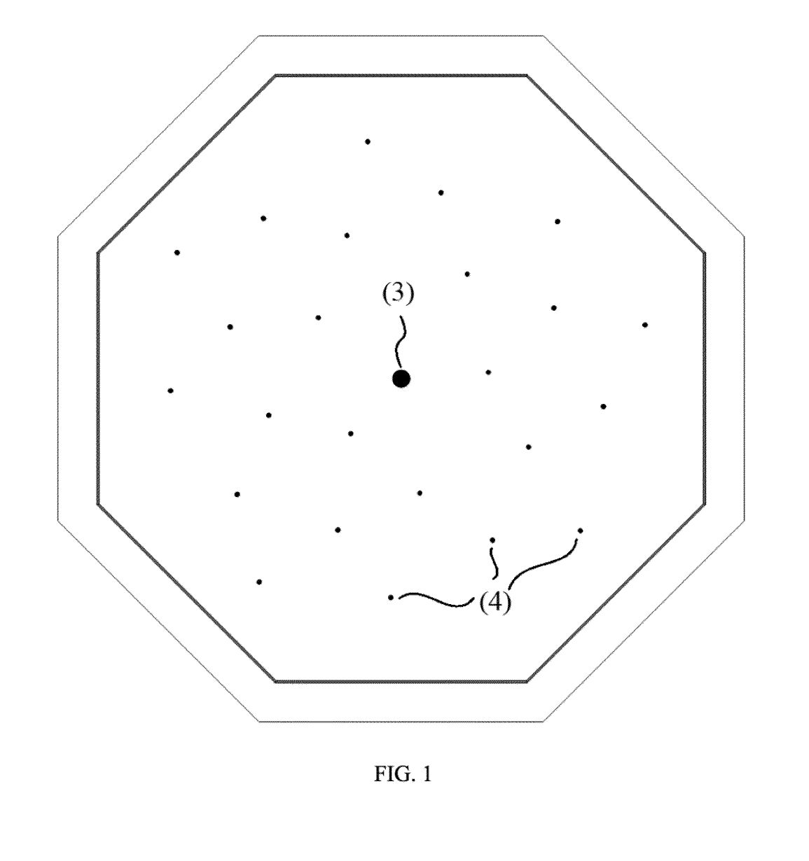

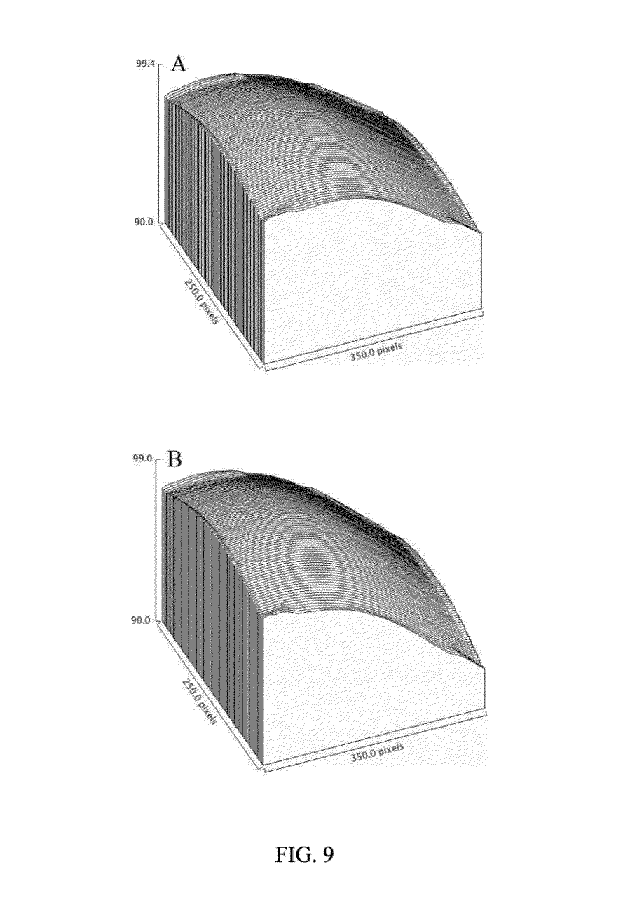

The primary innovation of the invention is the use of a phased microphone imaging array 1 and repeatable sound source 2 in tandem with beamforming techniques to obtain P_{inc} and P_{ref} in order to determine sound absorbing qualities of materials. FIG. 1 shows the phased microphone imaging array 1. A camera 3 is positioned at the center while microphones 4 are placed at optimized locations in order to detect the phase differences of incoming sound waves. The array 1 does not require a camera 3 as the beamforming generates a map to which the peak values can be found, as seen in FIG. 9-11 to be discussed later, but being able to overlay the results on an actual image helps in the analysis and determining exactly where the reflection occurs.

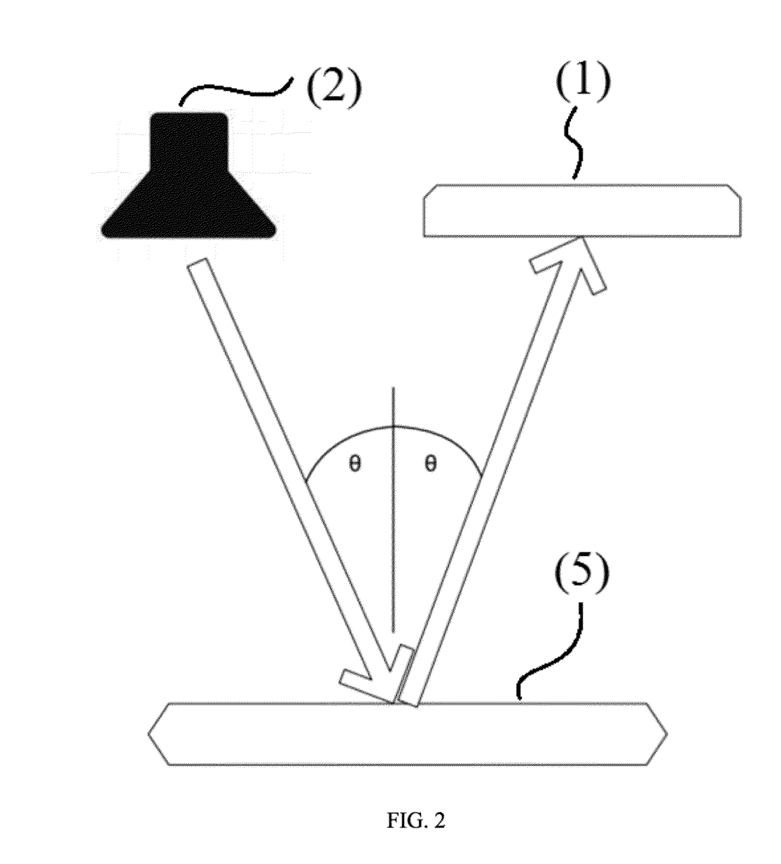

FIG. 2 illustrates how sound is generated and recorded by the invention. Once the array 1 and sound source 2 are in the desired positions continuous frequency noise is generated by the sound source 2. The noise need not be continuous but since absorption is a function of frequency it is useful to have data over a large range of frequencies. Sound waves then reflect off the material or surface 5 being tested. Due to the attributes of the material, a certain amount of energy is absorbed and a fraction reflected. As denoted by θ, the reflection occurs at an angle of incidence. Some energy is also scattered, but for most materials with flat surfaces sound does not scatter appreciably. Sound waves reflecting off the surface 5 are then received by the array I. Because of the separate locations of the microphones 4 there is a time lag in which each microphone 4 registers the wave generating a phase difference.

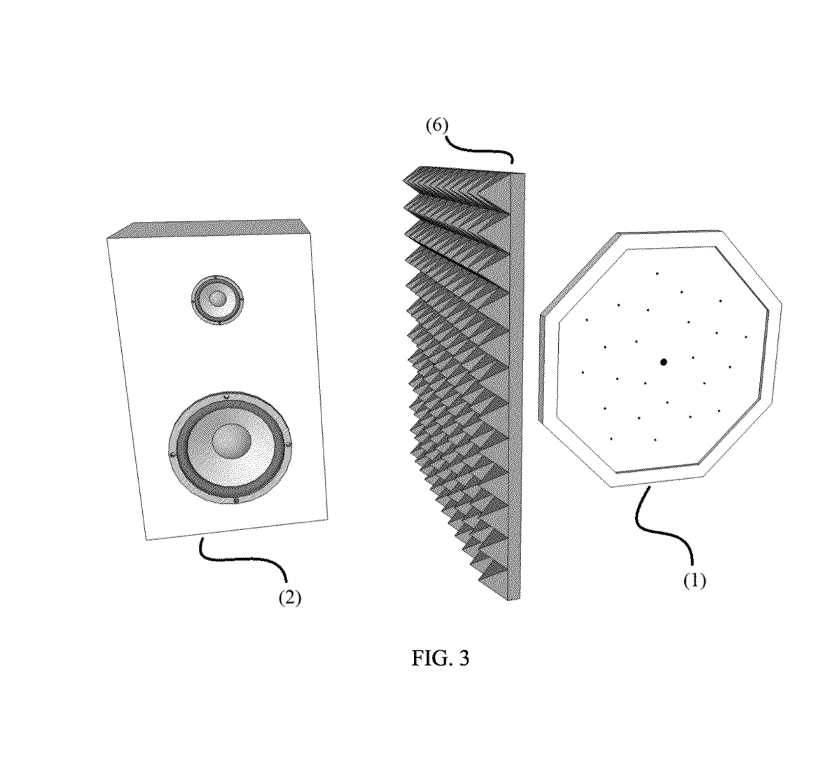

When the sound source 2 and array 1 are relatively close a complication called bleedover may occur. This is when the source 2 is so loud that it can be directly picked up by the phased array 1 even if the source 2 is projecting directionally away from it. Extra energy that is not being reflected from the surface 5 but coming directly from the source 2 skews the results making it appear as if the material is a better reflector than it actually is and lowering the calculated a. To mitigate this problem bleedover protection 6 is implemented as shown in FIG. 3. The protection just has to be a physical barrier separating the source 2 and array 1, but the better at absorbing sound the more accurate the results will be. That is why acoustical foam has been implemented in testing and can be seen in FIG. 3.

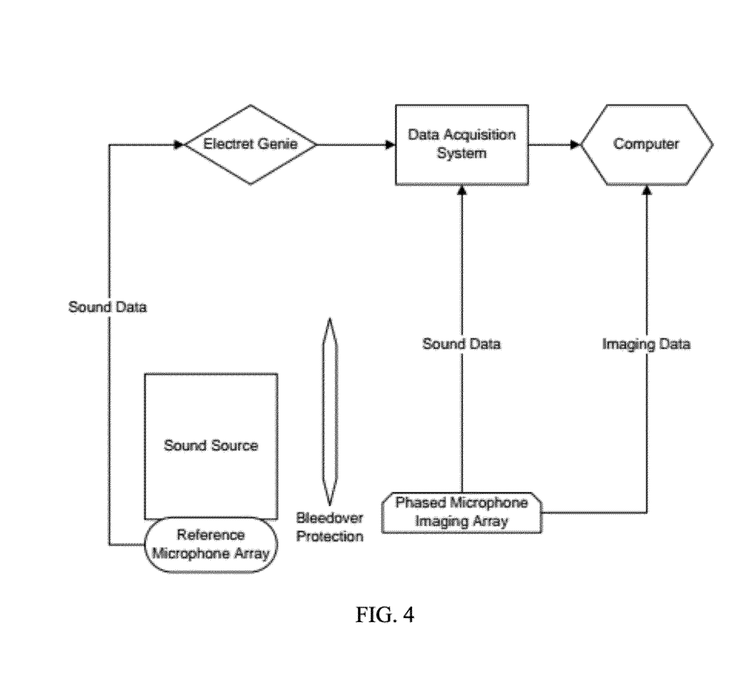

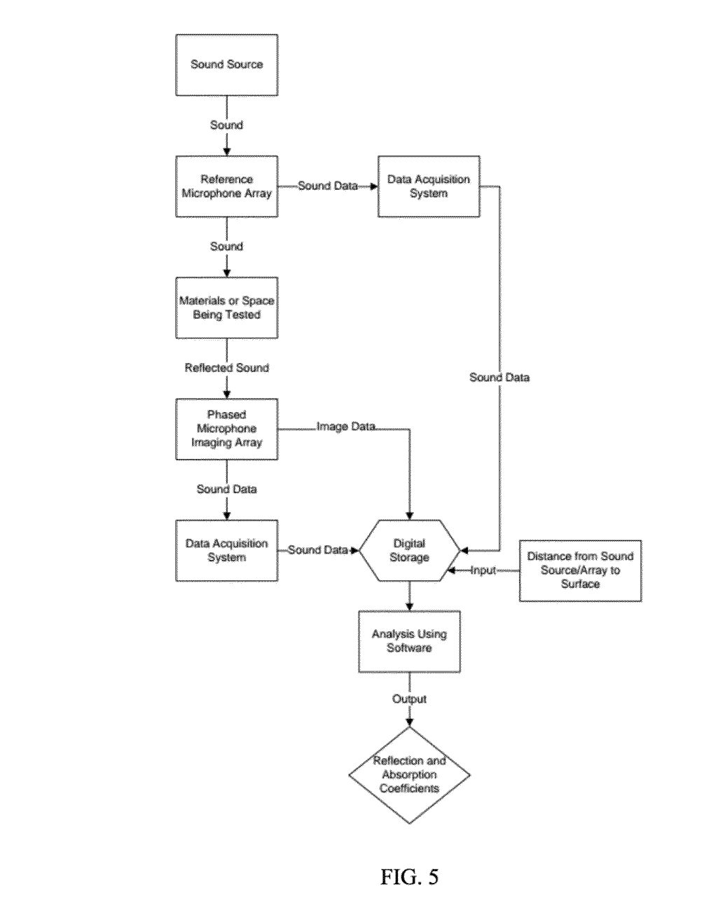

FIG. 4 is a flow diagram describing the physical components and how they are setup relative to each other. As previously mentioned, there is the sound source 2, bleedover protection 6, and phased microphone imaging array 1. Attached to the front of the sound source 2 is a reference microphone array 7 that directly measures sound at the source 2. That data is then passed on to an electret genie, which applies a voltage to the microphones of the reference array 7 while relaying the signals. Acoustic data is then passed on from the electret genie and the phased array 1 to a data acquisition system. From there all of the sound data is passed to a computer. The imaging data goes straight from the phased array I to the computer. The flow diagram in FIG. 5 describes more accurately how data moves through the system. A sound is initiated by the source 2 and travels past the reference microphones. It is important to note that the reference array 7 is small and does not block sound transmission in any appreciable fashion. The reference array 7 then sends its data to an acquisition system, which includes the electret genie, and goes to a digital storage device. Sound that traveled past the reference array 7 then continues on to the test material which it then reflects off of. Reflected waves are recorded by the phased array I as well as images through its camera 3. Acoustic data is also sent to an acquisition system which sends it to the digital storage device. Next, the distances from the array I and sound source 2 to the reflection point are recorded as well as θ if not normal. It is recommended that distance be recorded via a laser distance finder 8 as it is the easiest and most accurate method, although any reliable method can be used. With the acoustic, image, and distance data recorded the beamforming software can calculate α and R. The mathematics and beamforming process will be discussed later.

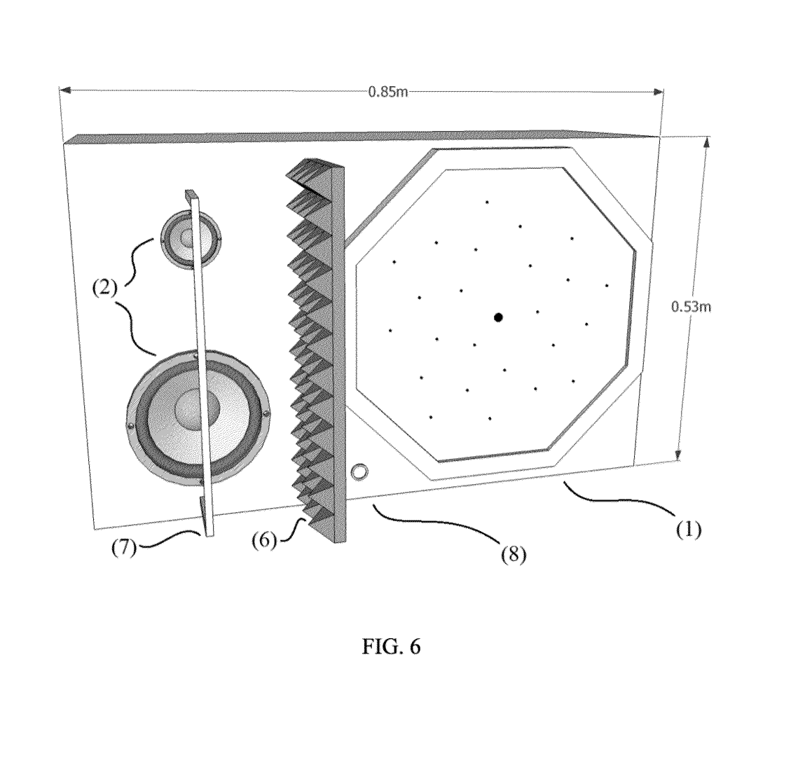

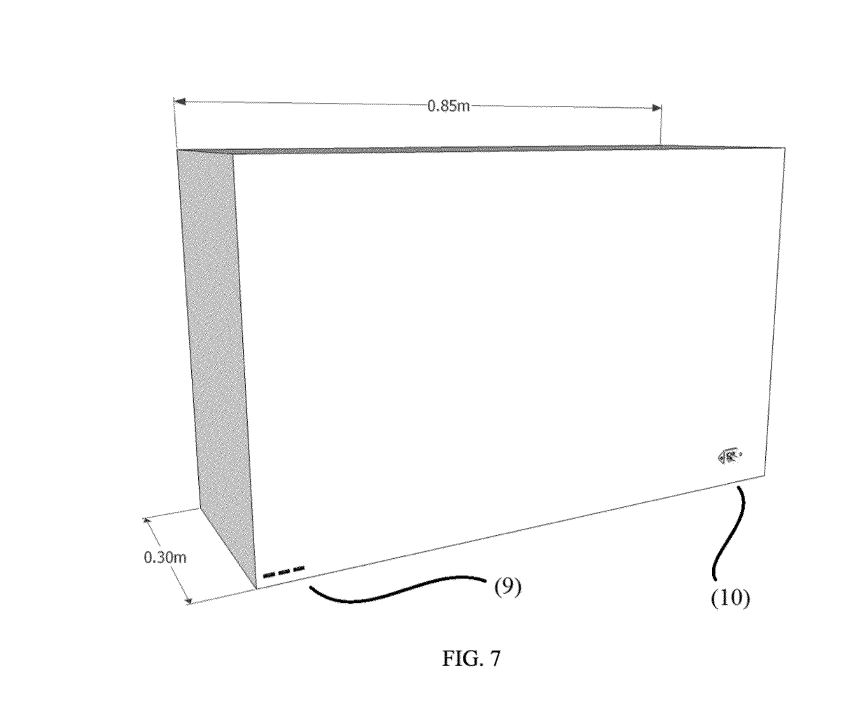

Components shown in FIG. 3 are of relatively modest size with the largest being the phased array 1 itself at approximately half a meter across. This lends the invention to possibly being made into a relatively compact unit. FIG. 6 and FIG. 7 depict a concept for a version of the invention. Due to the sound source 2 and phased array I being fixed directly next to each other, this unit would only be able to be used for normal incidence cases. To test at varying θ the source 2 and array 1 would need to move independently of one another. FIG. 6 depicts the front and shows the phased microphone imaging array 1 and sound source 2 side by side in the same plane. Bleedover protection 6 is built in and separates the two eliminating line of sight. Because the sound source 2 and phased array 1 are in the same plane there need only be one laser distance finder 8 to measure the distance to the test surface 5. Also shown is the reference microphone array 7 on the front of the sound source 2. Housed internally is the data acquisition system and electret genie. FIG. 7 depicts the back with ports 9 for connecting electronic devices such as the computer with beamforming software and a power inlet 10. The phased array 1, sound source 2, and data acquisition system require standard 120V wall outlet power. The electret genie and reference microphones require a 9V battery. The laser distance finder 8 will use whatever is required by the manufacturer.

Key to calculating the R and α is a system calibration. Delving into the mathematics of R and α will help explain the need to calibrate. To find the acoustic coefficients sound power is required. Sound power is defined as sound energy per unit time or mathematically as

P=I×Area

Where intensity is a logarithmic value measured in decibels making acoustic power logarithmic. R is defined using linearized acoustic power, particularly as

$$R = \frac{{P}_{ref}^{2}}{{P}_{inc}^{2}}$$

Where P_{ref} and P_{inc} have been linearized and are taken at the surface 5. Because some sound energy will be absorbed by the materials R will be a decimal value between 1 and 0. Knowing the amount of sound energy reflected, α can be defined as the fraction of energy absorbed or

α=I−R

Beamforming software outputs P_{ref}. However, P_{inc} is not known which is why the calibration is required. A very hard reflective surface 5 is desired for the calibration, one that approaches no absorption. If a test on a materials surface 5 such as this is conducted it can be assumed that there is practically no acoustic energy absorbed meaning that P_{inc} and P_{ref} are treated as the same. Knowing this and P_{ref} from the absorptive material, R and α can be determined. To avoid drift in the microphones 4, a change in the bias overtime, it is advised that a calibration test be conducted periodically, perhaps once a year. It also may be possible to theoretically calculate P_{inc} using the reference microphones and point source spherical radiation. Due to the complexities of the sound source 2 it appears doing the calibration is an easier and a more accurate means of calculating Pa.

It has been established that calculating sound power through beamforming is key to the invention. Beamforming is a powerful and flexible method that utilizes a phased array 1. Due to the different locations of the microphones 4 sounds waves generate phase differences from which a two dimensional map of sound intensity can be generated. This technique can differentiate between different sources and their intensities which allows for the beamforming to focus only on the data from the main source 2 and ignore all others, something that other in-situ techniques cannot. From the phase differences a cross spectral matrix can be formed. Each cell in the matrix represents the phase difference between two unique microphones 4 in the array 1.

After the cross spectral matrix is calculated, it is divided by the mean of the sound intensity from the reference microphones. The reference microphones always maintain the same distance from the source 2 so theoretically dividing all cross spectral matrices by the reference mean will normalize the data. This way it doesn't matter how loud the source 2 is, all data is normalized to be the same. The sound source 2 could produce sound at half the intensity or twice the intensity; it will still yield the same normalized data for the same material. Another added benefit is that each microphone 4 need not be calibrated before testing because of the use of ratios. Since sound power is calculated with the microphone arrays relative to each other the use of ratios nulls uncertainties in the bias. Because of this many other uncertainties inherent in the system that would become problematic if trying to linearize and report actual values for every microphone 4 can also be avoided.

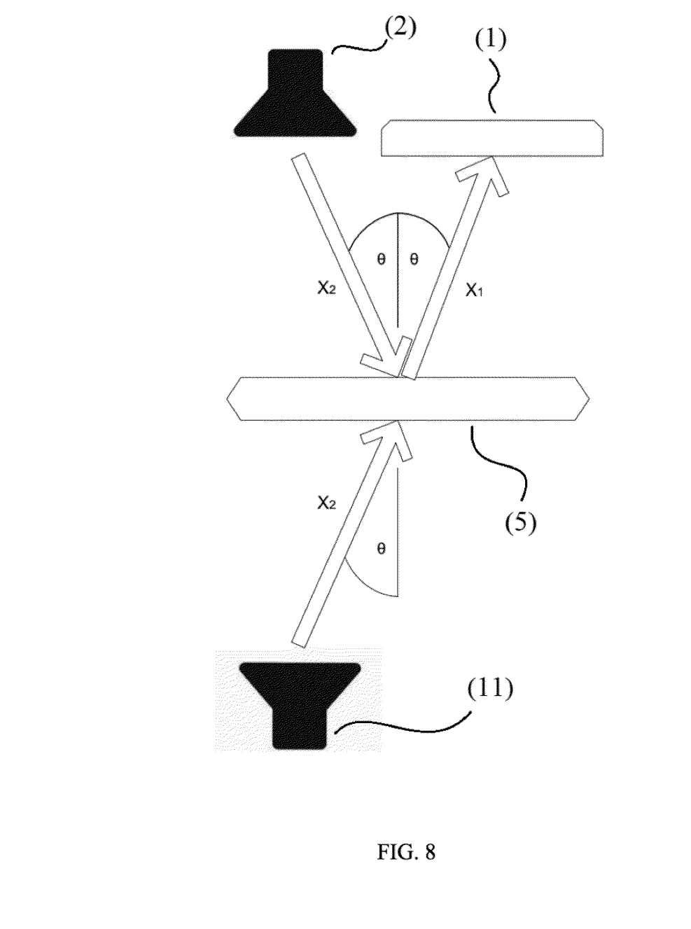

The next thing needed to calculate Pa is the distance from the array 1 to the reflection point, x₁, and from the sound source 2 to the reflection point, x₂, as illustrated by FIG. 8. What the beamforming is actually doing with this information is creating a virtual source 11 on the other side of the surface 5 generating a mirror image of the sound source 2. The imaginary sources 11 distance from the array 1 is the sum of x₁ and x₂. Now that the geometry between the array 1 and the virtual source 11 is known P_{ref}, which to the array 1 from the virtual source 11 is just power at distance x₂, can be found. It is assumed that sound propagates as a spherical point source. From the known sound power at the array 1 and distance from the source 2 to the array 1 P_{ref} can be calculated. Using the virtual source technique allows the source 2 and array 1 to be placed at any arbitrary distance from the surface 5 without any problems. For more information on beamforming refer to “What is Beamforming?” Berlin Beamforming Conference, 2008.

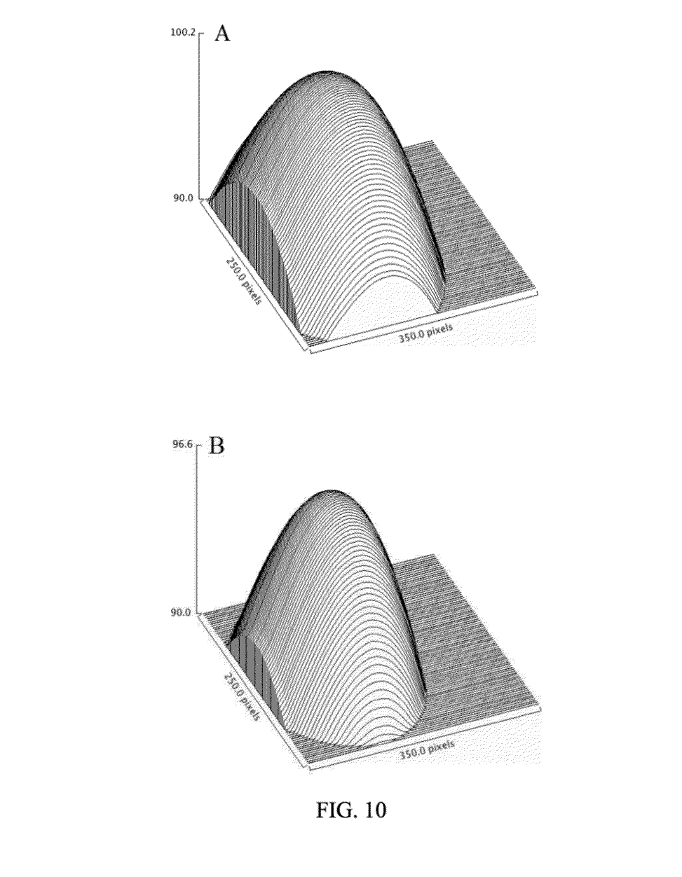

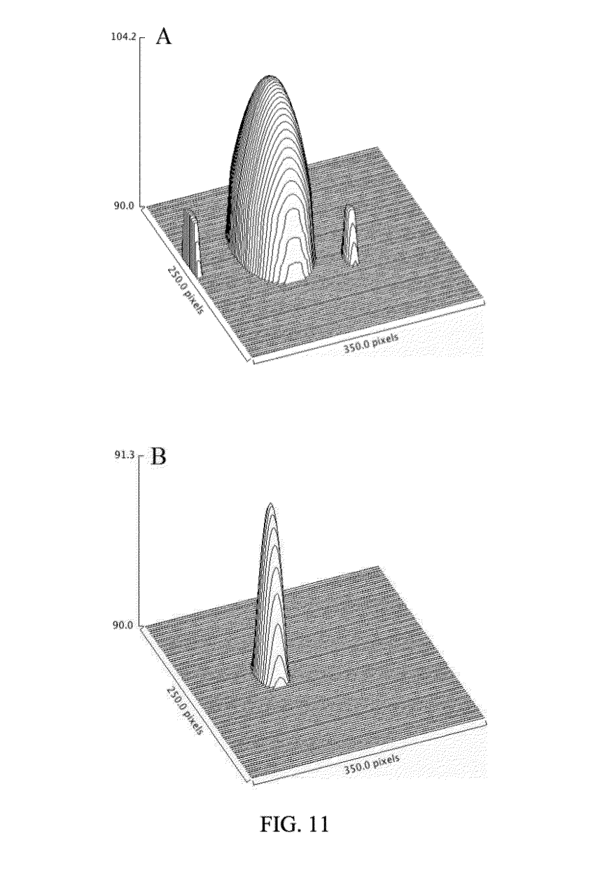

FIG. 9 to 11 are plots using beamforming. The vertical axis is intensity from which P_{ref} is calculated; the horizontal plane is the image from the camera 3. Because the sound source 2 was the only thing producing noise during the test there is only one peak, the approximate location of the reflection. FIG. 9 has the broadest shapes because it is the lowest frequency. Resolution of the array 1 becomes worse with decreasing frequency because wave lengths start to become much larger in relation to the microphone 4 distances from one another. This is a consequence of the Rayleigh resolution limit and once the wavelength becomes half the diameter of the phased array 1 it can no longer determine where peak resolution is. These figures are within that limit and the largest peak is assumed to be that of the reflection. Even if there were other walls close to the array 1 causing other peaks the beamforming would still be able to tell distinctly between all the reflections and pick the largest peak as the reflection intensity ignoring the others. FIG. 9-11A is water at 2.9 (cm) deep, a good reflector. FIG. 9-11B is carpet, a good absorber. FIG. 9A and FIG. 9B show that at low frequencies both materials have about the same reflectivity with water slightly better. FIG. 10A and FIG. 10B show that at higher frequencies the resolution improves as the curves are sharper and that carpet is starting to absorb more energy than water. FIG. 11A and FIG. 11B continue this trend with even sharper curves while there is an even wider gap in intensity between water and carpet. This makes sense as water creates a smooth flat surface which promotes good reflections at all frequencies. Carpet however has many small cavities which produce lots of edges, when wave lengths become small enough they can travel into these cavities and dissipate inside as supported by the data.

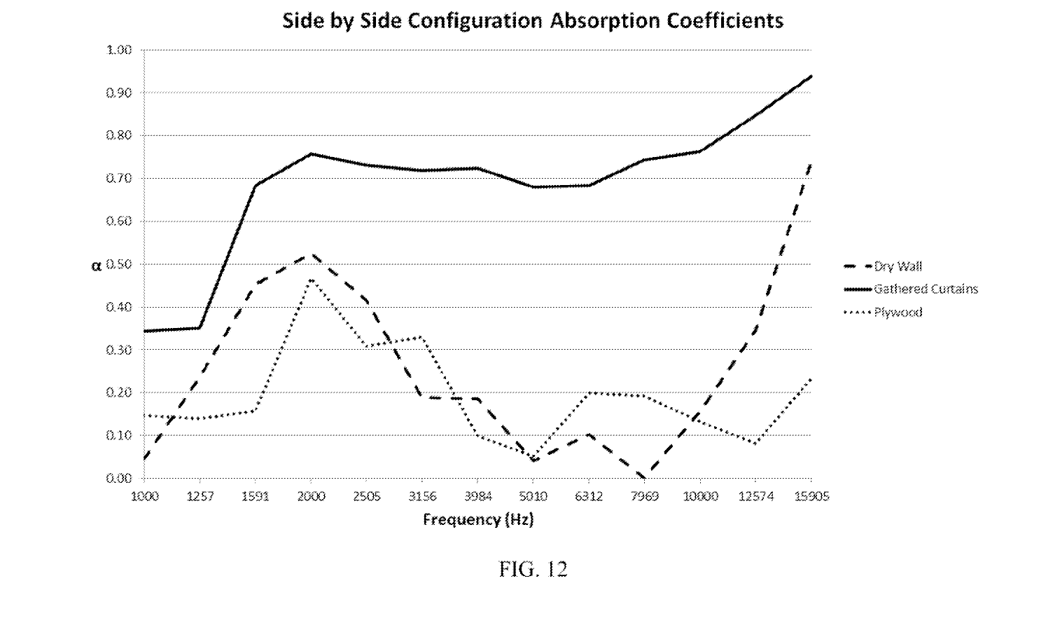

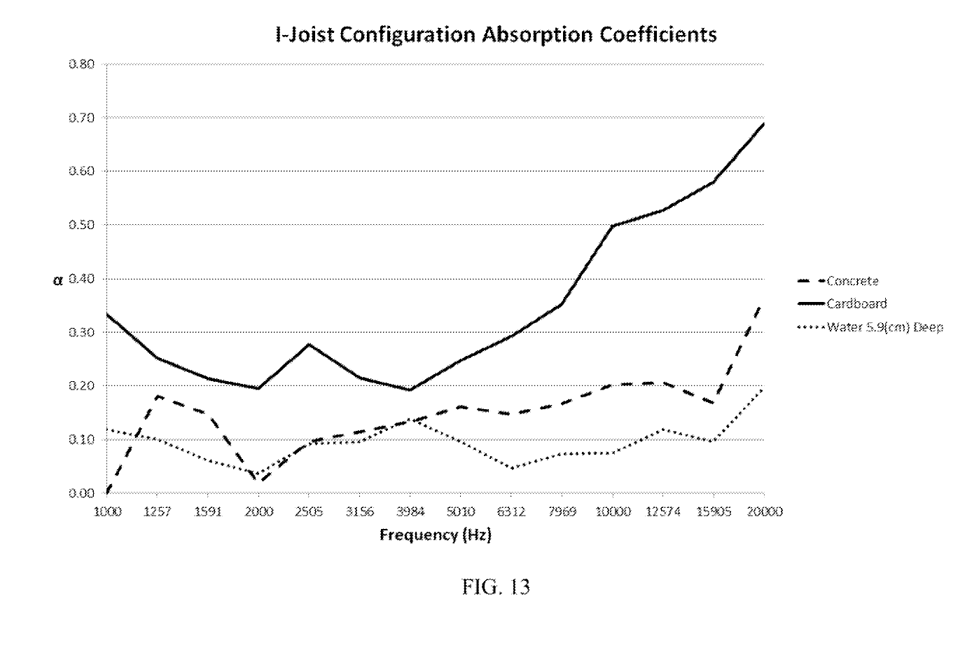

Verification of the effectiveness of the invention is important. Therefore, two configurations were tested. One on a cart referred to as the Side by Side configuration, the other as the I-Joist configuration suspended above the ground. Side by Side was pointed at a wall where materials were hung to be tested, I-Joist pointed at the ground where test materials were laid. With both configurations many materials were tested. FIG. 12 shows a of three materials for the Side by Side configuration and FIG. 13 α for three different materials for the I-Joist configuration. These curves appear typical for materials and are distinct from each other. For both configurations there was not one material that was the best reflector at every frequency to use for calibrating. Therefore, the best reflector at each frequency was used to create a composite curve of P_{inc}.

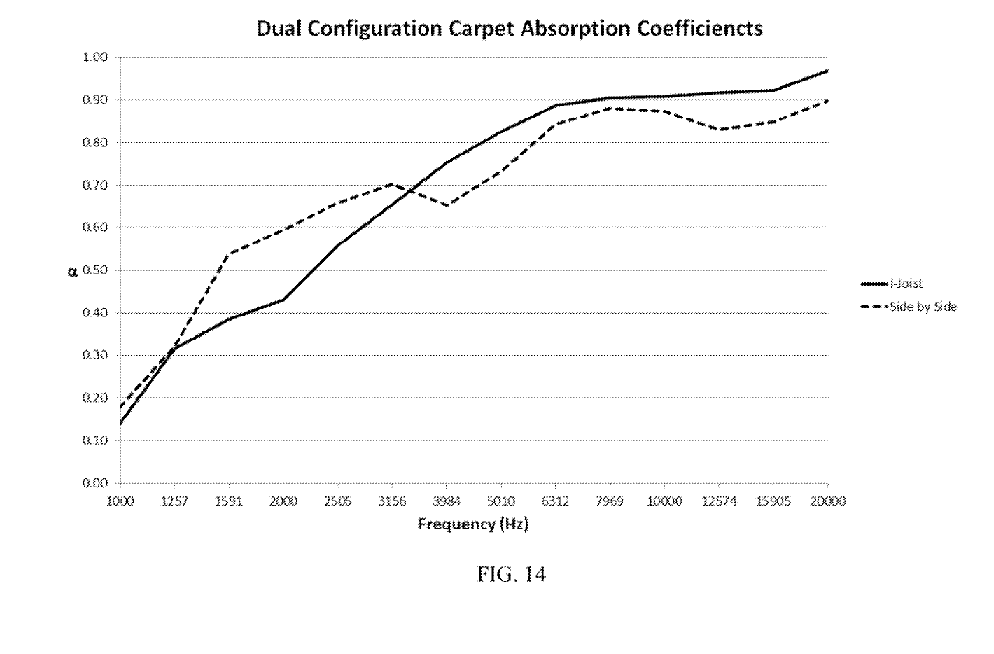

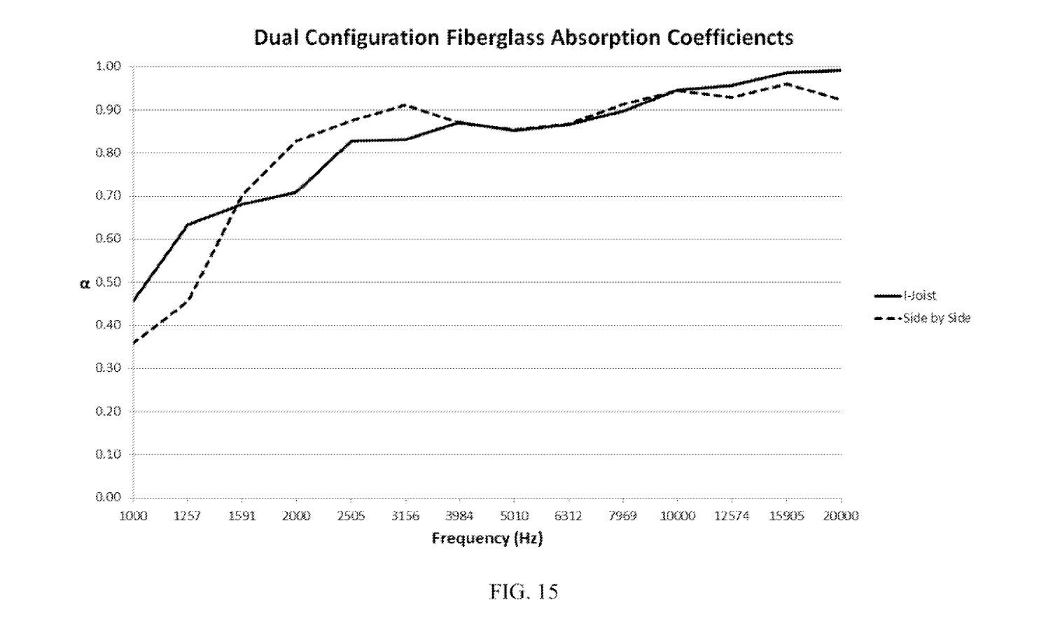

FIG. 14 shows the absorption curves of the same carpet tested with both configurations. Both align fairly well indicating that the system is versatile under different conditions. FIG. 15 shows the absorption curves of fiberglass tested with both configurations. Again, there is a close correlation which strengthens the argument that this invention generates accurate results under different conditions.

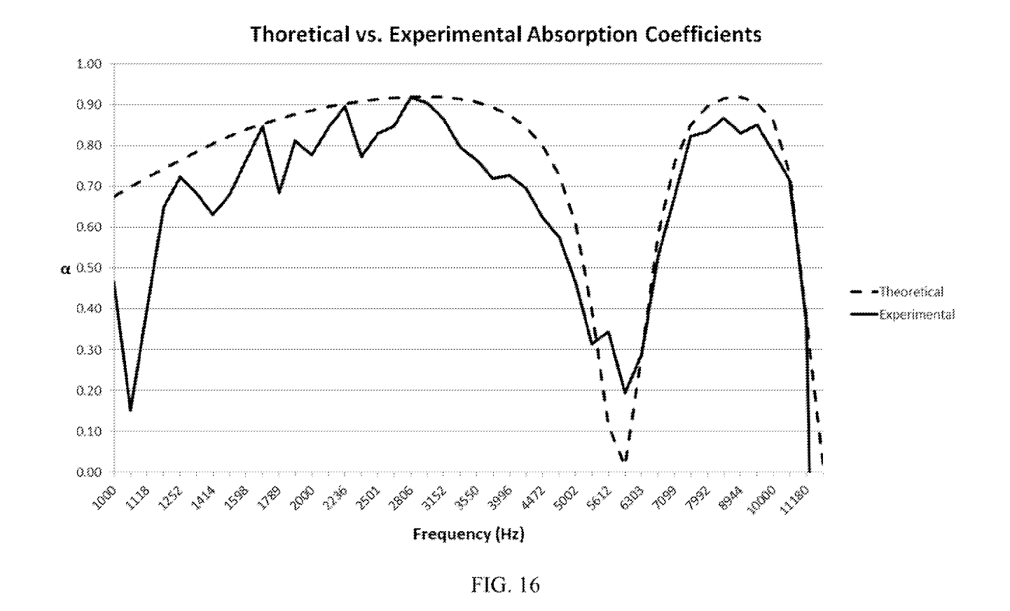

FIG. 16 illustrates theoretical versus experimental values for a curtain stretched into a plane above the ground creating a cavity. Transmission from one fluid to another at normal incidence was assumed to generate an absorption equation. At certain frequencies the reflected wave from the surface of the curtain and inside the cavity are out of phase which leads to large absorptions and at others they are completely in phase which leads to large reflections seen in FIG. 16 as the peaks and nulls. From the figure it is apparent that theory matches the experimental data very nicely which again supports effectiveness of the invention.

1. A method for measuring absorption and reflection coefficients of materials or spaces comprising of a repeatable sound source, a phased microphone imaging array, and beamforming techniques to generate sound power incident and reflected. Sound from the source reflects from a test surface and is recorded by the phased array which utilizes beamforming software to calculate sound power yielding the acoustical coefficients.

2. Sound source and array from claim 1 facing toward a test material or space at any angle of incidence.

3. Sound source and array from claim 2 in a coplanar configuration.

4. Sound source and array from claim 3 in the same plane.

5. Sound source and array from claim 2 with an unobstructed view of the materials or space in question.

6. Sound source and array from claim 5 producing a noise and recording the sound reflection.

7. Use of data recorded from the apparatus of claim 6 to calculate a reflection or absorption coefficient.

8. Use of a distance measuring device to determine the distance from the sound source and array configuration in claim 5 to the material or space to be, or currently being, tested.

9. Use of sound blocking or absorbing material between the sound source and array to protect the array from bleedover noise in claim 5.

10. Use of microphones near the sound source to directly measure intensity and sound power from the source in claim 5.

11. Using the sound source and array configurations from claim 5 to calibrate the system with an excellent reflector to generate a near zero energy loss reflection.
